(19) United States
(12) Patent Application Publication
(10) Pub. No.: US 2014/0145445 A1
(43) Pub. Date: May 29, 2014

(54) MARINE TURBINE ASSEMBLY

(71) Applicants: Yves Richer, Otterburn Park (CA); Alexandre Doin, Montreal (CA); Jacques Ruer, Fourqueux (FR); Didier Collart, Saint-Bruno (CA)

(72) Inventors: Yves Richer, Otterburn Park (CA); Alexandre Doin, Montreal (CA); Jacques Ruer, Fourqueux (FR); Didier Collart, Saint-Bruno (CA)

(73) Assignee: CENTRE HYDROLIEN INDUSTRIEL QUEBECOIS INC., Ste-Julie ,Quebec (CA)

(21) Appl. No.: 13/983,547

(22) PCT Filed: Feb. 6, 2012
(86) PCT No.: PCT/CA2012/050064

§ 371 Date: Oct. 2, 2013

Related U.S. Application Data
(60) Provisional application No. 61/439,510, filed on Feb. 4, 2011.

(51) Int. Cl. F03B 13/10; B63B 39/03

(52) U.S. Cl. CPC F03B 13/10; B63B 39/03
USPC 290/54; 114/121

(57) ABSTRACT

There is described a marine turbine assembly comprising a frame having a receiving surface and a front end; at least one turbine mounted to the receiving surface of the frame and comprising a rotor and a plurality of blades projecting therefrom, the rotor being operatively connectable to an electrical generator for generating electrical energy from a water current. A ballast system is coupled to the frame and balancedly distributed around a perimeter thereof. The ballast system has at least one compartment with at least one aperture for selectively receiving and selectively expelling pressurized fluid from a source of pressurized fluid, thereby controlling at least one of a trim and a buoyancy of the marine turbine assembly.

### CROSS-REFERENCE TO RELATED APPLICATIONS

The present application claims priority under 35 USC 119(e) of U.S. Provisional Patent Application No. 61/439,510, filed on Feb. 4, 2011, the contents of which are hereby incorporated by reference.

### TECHNICAL FIELD

The present invention relates to the field of marine turbines, and particularly to submersible marine turbines.

### BACKGROUND OF THE ART

Marine turbines use water to generate electrical energy. Most of the marine turbines that have been developed generate electrical energy from either tides or ocean currents. Therefore, these marine turbines have been designed for being installed in oceans or seas.

Fluvial currents also represent a source of renewable energy from which electrical energy may be generated. However, some of the marine turbines that have been developed for oceans may not be adequate for rivers. For example, debris such as snags, ice, sediments, and the like are present in rivers. The debris can be swept away by the fluvial current and may damage the blades and/or the rotor of a turbine immersed into a river. Since the problem caused by debris is of less of importance in oceans compared to rivers, at least some of the marine turbines that have been developed for oceans are not adapted for rivers.

Therefore, there is a need for an improved marine turbine.

### SUMMARY

In accordance with a first aspect, there is provided a marine turbine assembly comprising: a frame having a receiving surface and at least one turbine mounted to the receiving surface of the frame and comprising a rotor and a plurality of blades projecting therefrom, the rotor being operatively connectable to an electrical generator for generating electrical energy from a water current. The marine turbine assembly also comprises a ballast system coupled to the frame and balancedly distributed around a perimeter thereof, the ballast system having at least one compartment with at least one aperture for selectively receiving and selectively expelling pressurized fluid from a source of pressurized fluid, thereby controlling at least one of a trim and a buoyancy of the marine turbine assembly.

In accordance with a second broad aspect, there is provided a ballast system for use with a marine turbine assembly having a frame, the ballast system comprising a body adapted to be coupled to the frame and balancedly distributed around a perimeter thereof; the body having at least one compartment with at least one aperture for selectively receiving and selectively expelling pressurized fluid from a source of pressurized fluid, thereby controlling at least one of a trim and a buoyancy of the marine turbine assembly.

In accordance with another broad aspect, there is provided a marine turbine assembly comprising: a frame having a receiving surface and a front end; at least one turbine mounted to the receiving surface of the frame and comprising a rotor and a plurality of blades projecting therefrom, the rotor being operatively connectable to an electrical generator for generating electrical energy from a water current; and a debris guard secured to the frame between the front end of the frame and the turbine and projecting from the receiving surface of the frame for protecting the turbine from debris.

In accordance with another broad aspect, there is provided a marine turbine assembly comprising: a frame having a receiving surface; at least one turbine mounted to the receiving surface of the frame, the turbine comprising a rotor and a plurality of blades projecting therefrom, the rotor being operatively connectable to an electrical generator for generating electrical energy from a water current, each one of the blades having an internal manifold extending along at least a section of a leading edge thereof and in thermal communication with the leading edge, the internal manifold being fluidly connectable to a source of warm fluid for propagating the warm fluid therein in order to at least reduce ice frazil formation on the leading edge of the blades.

In the present specification, the expression “fluid” should be understood to mean any continuous, amorphous substance whose molecules move freely past one another and that has the tendency to assume the shape of its container, such as a liquid or a gas.

### BRIEF DESCRIPTION OF THE DRAWINGS

Further features and advantages of the present invention will become apparent from the following detailed description, taken in combination with the appended drawings, in which:

FIG. 1 is a front view of a marine turbine assembly provided with a debris guard, in accordance with an embodiment;

FIG. 2 is a side view of the marine turbine assembly of FIG. 1;

FIG. 3 is a top view of the marine turbine assembly of FIG. 1;

FIG. 4 is a closed-up view of the debris guard of FIG. 1;

FIG. 5 is a cross-sectional view of a bar for a debris guard, in accordance with a first embodiment;

FIG. 6a schematically illustrates a flow of pressurized fluid in a debris guard, in accordance with a first embodiment;

FIG. 6b schematically illustrates a flow of pressurized fluid in a debris guard, in accordance with a second embodiment;

FIG. 6c schematically illustrates a flow of pressurized fluid in a debris guard, in accordance with a third embodiment;

FIG. 7 is a cross-sectional view of a bar for a debris guard, in accordance with a second embodiment;

FIG. 8 schematically illustrates a flow of a hydraulic fluid in a marine turbine assembly, in accordance with an embodiment;

FIG. 9 is an isometric view of a marine turbine assembly comprising four elongated ballast tanks in a standing position, in accordance with an embodiment;

FIG. 10 is a side view of the marine turbine assembly of FIG. 9;

FIG. 11 is an isometric view of the marine turbine assembly of FIG. 9 with the four elongated ballast tanks in a laying position, in accordance with an embodiment;

FIG. 12 is a side view of the marine turbine assembly of FIG. 11;

FIG. 13 illustrates a power assembly comprising a hydraulic engine and an electrical generator secured to a base of a marine turbine assembly, in accordance with an embodiment;

FIG. 14 is a cross-sectional view of the power assembly of FIG. 13;

FIG. 15 is an isometric view of a turbine assembly provided with de-icing blades, in accordance with an embodiment;

FIG. 16 schematically illustrates a flow of warm fluid from a warm fluid source to a de-icing blade, in accordance with an embodiment;

FIG. 17 schematically illustrates a flow of water in a turbine up to a de-icing blade, in accordance with an embodiment;

FIG. 18 is a cross-section of a turbine comprising a water heating system for warming-up blades, in accordance with an embodiment;

FIG. 19 is a cross-sectional isometric view of the turbine of FIG. 18;

FIG. 20 is a cross-sectional view of a rotor chamber comprised in the turbine of FIG. 18;

FIG. 21 is an isometric view of the front portion of a marine turbine assembly provided with a shock-absorbing device, in accordance with an embodiment;

FIG. 22 is a side view of the shock-absorbing device of FIG. 21 in a rest position; and

FIG. 23 is a side view of the shock-absorbing device of FIG. 21 in a deformed position.

### DETAILED DESCRIPTION

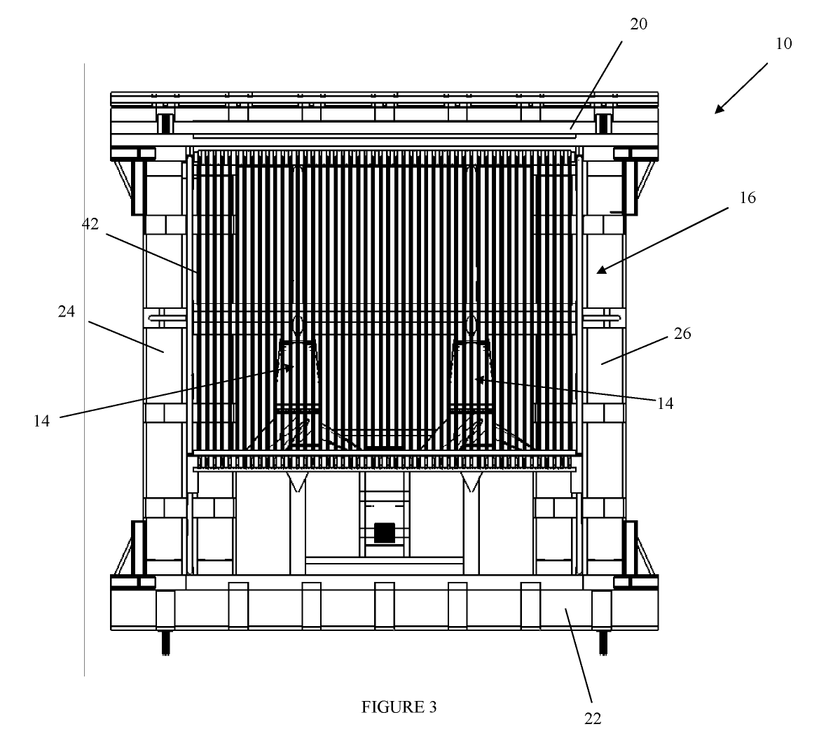

FIGS. 1, 2, and 3 illustrate one embodiment of a marine turbine assembly 10 for generating electrical energy from a fluvial current. The marine turbine assembly comprises a submersible base 12, two turbines 14, and a debris guard 16.

The base 12 illustratively comprises a frame (not shown) to which are coupled a front or upstream ballast compartment 20, a rear or downstream ballast compartment 22, and two lateral ballast compartments 24 and 26, which are all connectable to a source of pressurized fluid (not shown), such as a source of pressurized air for example. The ballast compartments 20, 22, 24, and 26 may be coupled to the frame of the base 12 using any suitable means. For example, the ballast compartments 20, 22, 24, and 26 may be attached to the frame of the base 12 using ropes or the like. Alternatively, they may be inserted into recesses (not shown) provided on the frame and adapted to receive therein the ballast compartments 20, 22, 24 and 26.

Also, the ballast compartments 20, 22, 24 and 26 may be in fluid communication with one another, thus forming a single ballast compartment unit. Alternatively, the ballast compartments 20, 22, 24 and 26 may form separate and independents units, each unit being individually coupled to the frame along a perimeter thereof and not in fluid communication with the other units.

The source of pressurized fluid can be positioned on the base 12. Alternatively, the source of pressurized fluid may be located outside from the marine turbine assembly 10. For example, the source of pressurized fluid may be located on the bank of a river when the marine turbine assembly 10 is immersed in the river.

Each ballast compartment 20, 22, 24, and 26 is connected to a valve system fluidly connected to the source of pressurized gas. Each valve system controls the entry and evacuation of water and pressurized gas for its respective ballast compartment 20, 22, 24, and 26, an aperture (not shown) being illustratively provided on each ballast compartment 20, 22, 24, 26 for allowing such entry and evacuation of the pressurized gas. The aperture may comprise a single opening or alternatively comprise an inlet separate from an outlet, the inlet being used for receiving the pressurized gas into each ballast compartment 20, 22, 24 and 26 and the outlet being used for evacuating the pressurized gas. A control unit (not shown) in communication with the valve systems is used for controlling the valve systems. By controlling the quantity of water and pressurized gas in the ballast compartments 20, 22, 24, and 26, the buoyancy (i.e. the force exerted by water opposing the assembly's weight and which impacts the underwater depth) of the marine turbine assembly 10 can be adjusted. For example, the marine turbine assembly 10 may float by filling the ballast compartments 20, 22, 24, and 26 entirely with pressurized gas while it may be deposited on the stream bed of a river, for example, by filling the ballast compartments 20, 22, 24, and 26 entirely with the river water.

Although the marine turbine assembly 10 is illustrated as comprising four ballast compartments 20, 22, 24, and 26, the number of ballast compartments may vary as long as the marine turbine assembly 10 is adequately balanced. As such, it may be sufficient to provide two identical ballast compartments on opposite ends of the base 12. For instance, the base 12 may only comprise the upstream and downstream ballast compartments 20 and 22. Alternatively, the base 12 may only comprise the two lateral ballast compartments 24 and 26. Still, providing the four ballast compartments 20, 22, 24, and 26 enables more precise control of the buoyancy of the overall marine turbine assembly 10.

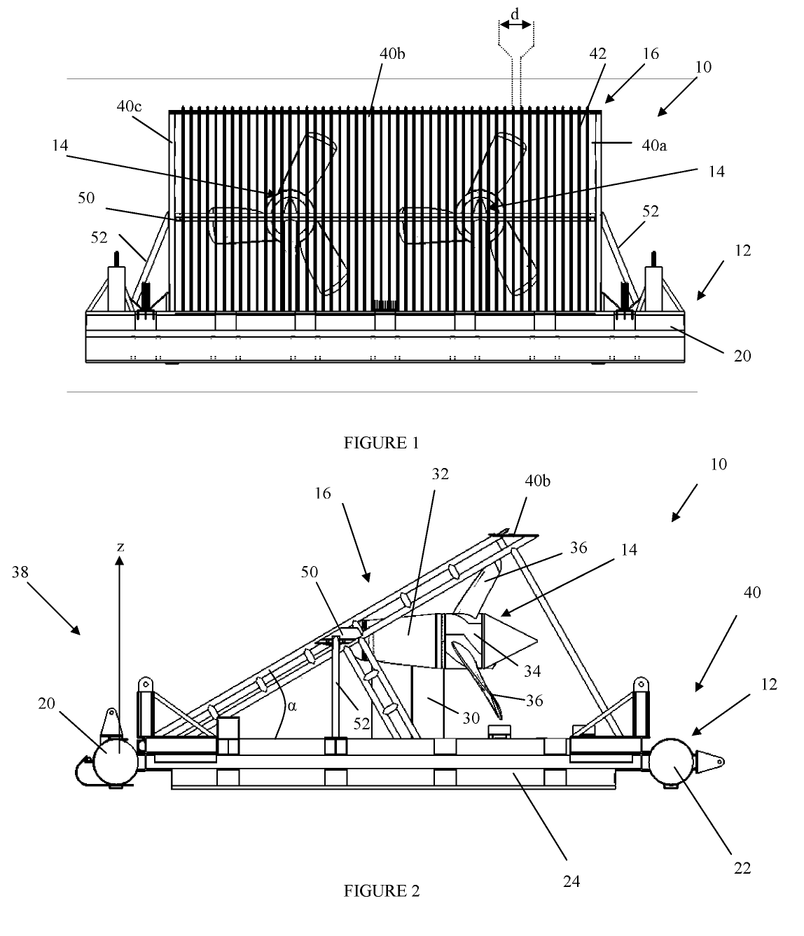

As illustrated in FIG. 2, each turbine 14 comprises a post 30 extending upwardly from the base 12, a nacelle 32 secured to the post 30, a rotor 32 rotatably secured to the nacelle 32, and a plurality of blades 36 projecting from the rotor 34. A gear box (not shown) is located within the nacelle 32. The gear box is operatively connected to the rotor 34 and an electrical generator (not shown) for converting the rotational motion of the rotor 34 into electrical energy. The electrical generator may be located on the marine turbine assembly 10. Alternatively, the electrical generator can be located on the bank of the river. In this case, the turbine assembly 10 further comprises a hydraulic pump (not shown) located in the nacelle 32 and operatively connected to the gear box. The hydraulic pump is also fluidly connected to the electrical generator, via a hydraulic engine for example, for propagating a hydraulic fluid thereto in order to activate the electrical generator and generate electrical energy.

The marine turbine assembly 10 is deposited on the stream bed of a river while facing the fluvial current of the river. The front or upstream and rear or downstream ends 38 and 40 of the marine turbine assembly 10, and thus of the base 12, are therefore referred to as the upstream and downstream ends, respectively. The river fluvial current exerts a force on the blades 36 of each turbine 14, which drives the rotation of the rotor 34. Then, the rotation of the rotor 34 drives the gear box and the electrical generator via the hydraulic pump, if any, and electrical energy is generated.

The debris guard 16 is positioned upstream to the turbine, i.e. between the turbines 14 and the front end 38, so that the river current has to first pass through the debris guard 16 before reaching the turbines 14 when the marine turbine assembly 10 is immersed while facing the water current. The debris guard 16 is sized and shaped to protect the turbines 14 from debris.

The debris guard 16 comprises a frame 40a, 40b, and 40c extending upwardly from the base 12 and a plurality of bars 42 having one end secured to the base 12 and another end secured to the horizontal top frame portion 40b. As illustrated in FIG. 2, each bar 42 forms an angle α with the plane of the base 12. The value of the angle α is adequate for deflecting at least some debris. For example, the angle α may be comprised between about 20° and about 60°. In one embodiment, the angle α is substantially equal to about 30°.

Two following bars 42 are spaced apart by a distance d. The distance corresponds to the maximal size of “harmless” debris which may pass through the debris guard 16 and hit the turbines 14. In one embodiment, the distance d corresponds to the maximal size of “harmless” debris which may cause substantially no damage to the turbines 14 if they hit the turbines 14.

In one embodiment, the shape of the base 12 is substantially square with a side length of about 15 meters, and the base is provided with a thickness of about 1.4 meters. The debris guard 16 comprises about 50 bars 42 each having a length of about nine meters adequate for protecting the turbines 14 having a height of about four meters, and the distance d between two following bars 42 is about 20 centimeters.

The bars 42 may be made of any adequate material. In one embodiment, the material of which the bars 42 are made is chosen as a function of parameters such as: lightness, flexibility, resistance to impacts, low adherence for debris and/or frazil ice, etc. Examples of adequate materials comprise metal such as steel for example, polymers such as polyethylene for example, resin/fiber composite material such as glass reinforced plastic (glass/polyester material for example) or epoxy-Kevlar™-carbon composite material, or the like.

In one embodiment, the length of the bars 42 is chosen so that the projection of the bars 42 on the z-axis is at least equal to the maximal height of a turbine 14, and the number of bars 42 is chosen so that the length of the debris guard 16 is at least equal to the maximal distance between the blades 36 of the two turbines 14 including the blades 36. In the same or another embodiment, the characteristics of the debris guard 16, such as the dimensions of the bars 42, the spacing between following bars, and the like, are chosen to minimize the impact of the debris guard 16 on the fluvial current, i.e. to minimize any turbulences that may be caused by the debris guard 16.

While the present description refers to a debris guard 16 comprising parallel bars 42 upwardly extending from the base 12, it should be understood that other configurations are possible as long as the debris guard 16 protects the turbines 14 from debris having a minimal size. For example, the frame 40a, 40b, and 40c may be omitted. In another example, the bars 42 may extend between the frame portions 40a and 40c so as to be substantially parallel to the plane of the base 12.

While it is planar, it should be understood that the debris guard 16 may be provided with any other adequate shape. For example, the debris guard may have a rounded shape, a pointed shape, or the like.

In one embodiment, a reinforcement bar 50 extends between the frame portions 40a and 40c and the bars 42 are secured to the reinforcement bar 50 to strengthen the holding of the bars 42. The reinforcement bar 50 is secured at each end by support elements 52 which extend from the base 12. In one embodiment, the reinforcement bar 50 is secured to the front end of the turbines 14.

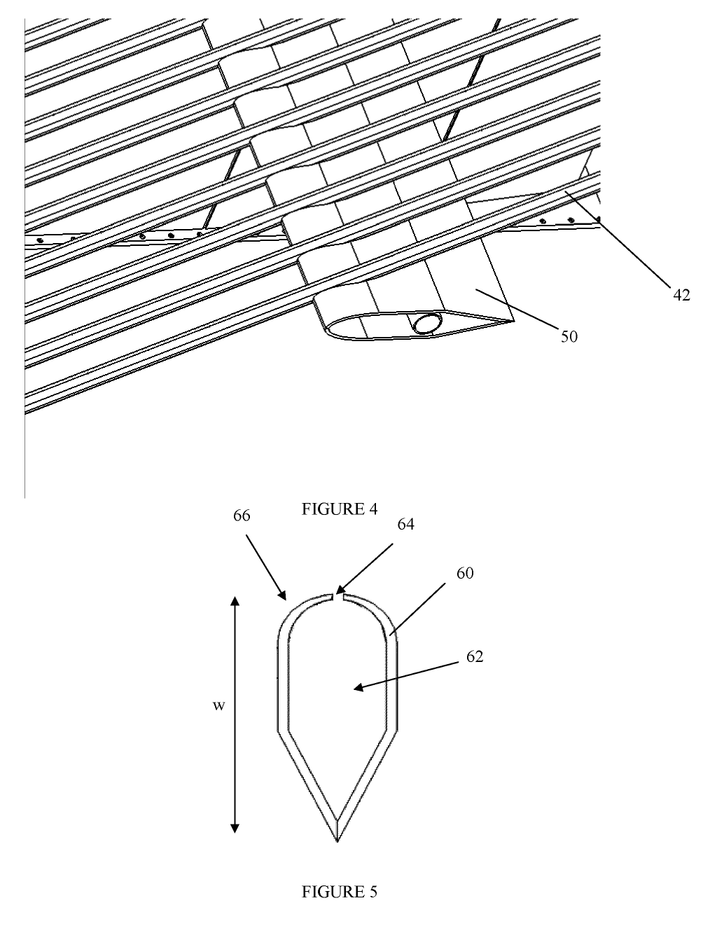

In one embodiment, the reinforcement bar 50 may have a streamlined cross-sectional shape to minimize its impact on the fluvial current by minimizing any turbulence it may generate, as illustrated in FIG. 4. The bars 42 may be at least partially built-in or fitted into the reinforcement bar 50 to form a smooth assembly so that the debris may substantially not hold on the debris guard 16 at the junction of the bars 42 and the reinforcement bar 50.

The bars 42 may have any adequate cross-sectional shape such as circular, square, rectangular, or the like. In one embodiment, the cross-sectional shape of the bars 42 is chosen so as to prevent debris from holding thereon and minimize any turbulence that may be caused by the bars 42. For example, the front or upstream section of the bars 42 which faces the fluvial current may be rounded for preventing debris from holding thereon while the rear or downstream section of the bars 42 may be pointed for reducing turbulence.

In one embodiment, the bars 42 may be hollow and provided with a plurality of apertures on their front or upstream face in order to expel a pressurized fluid through the apertures and remove potential debris hold thereon. In this case, the bars 42 are fluidly connected to a source of pressurized fluid, such as a source of pressurized air for example, which may be located on or outside of the marine turbine assembly 10.

FIG. 5 illustrates one embodiment of a hollow bar comprising an internal manifold 62 extending along at least a section of its length and a plurality of apertures 64 located on the upstream face 66 of the bar 60. The bar 60 has one end fluidly connected to a source of pressurized fluid which propagates the pressurized fluid in the manifold 62. The pressurized fluid then exits the bar 60 via the apertures 64, therefore dislodging any debris that would obstruct the apertures 64.

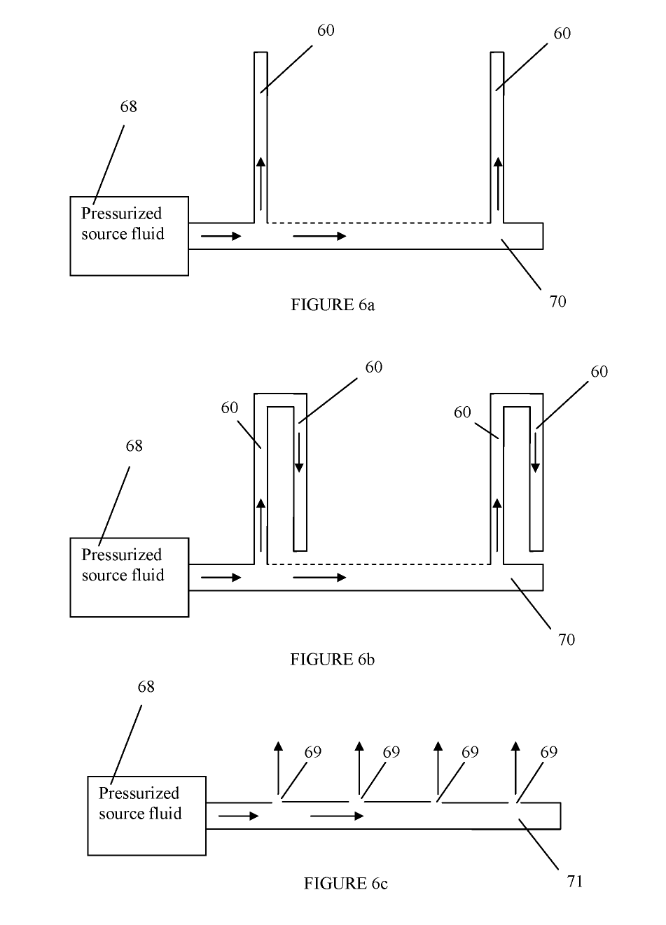

It should be understood that the bars 60 may be fluidly connected to the source of pressurized fluid in different adequate manners. For example, FIG. 6a illustrates one embodiment in which the bars 60 are fluidly connected to a source 68 of pressurized fluid in a parallel manner. In this case, a distribution pipe 70 is fluidly connected to the source 68 of pressurized fluid and each bar 60 is fluidly connected to the distribution pipe 70 so that the pressurized fluid flowing into the distribution pipe 70 may propagate in the manifold 62 of the bars 60. FIG. 6b illustrates one embodiment of a fluidic connection between the bars 60 and the pressurized fluid source 68 in which only some of the bars 60 are fluidly connected to the distribution pipe 70. In this case, two following or successive bars 60 are fluidly connected together at en end opposite to the base 12 so that only one of every two bars 60 is fluidly connected to the distribution pipe 70. In this case, the pressurized fluid entering a bar 60 fluidly connected to the distribution pipe 70 flows successively in two adjacent bars 60.

In an alternative embodiment illustrated in FIG. 6c, a distribution pipe 71 is fluidly connected to the source 68 of pressurized fluid and has a series of apertures 69 spaced apart for releasing fluid upwardly, these apertures being unconnected to the bars 60 of the debris guard 16. The upwardly released fluid travels up and gets pulled downstream by the flow of the current along the debris guard 16, thereby disengaging debris that may be caught on the bars 42 of the debris guard 16. This embodiment may be provided in conjunction with the embodiments illustrated in FIGS. 6a and 6b, by having a single distribution pipe 70 connected to bars 60 and having apertures 69 provided between the bars 60. Alternatively, the embodiment of FIG. 6c may be provided independently from distribution pipe 70 using a separate distribution pipe 71.

It should be understood that the pressure of the pressurized fluid within the manifold 62 is chosen to be superior to the pressure of the river water surrounding the apertures 64 so that no water may enter the manifold 62 and the pressurized fluid flowing into the manifold 62 may exit the bar 60 via the apertures 64.

In one embodiment, the bar 60 has a width w extending from its front rounded end 66 to its pointed end of about 20 centimeters and the rounded front end 66 of the bar 60 has a diameter of about 40 millimeters.

In one embodiment, the spacing between adjacent apertures 64, the size of the apertures 64, and the initial pressure or flow rate of the pressurized flow at the pressurized fluid source is chosen as a function of a desired pressure or flow rate within the bar 60. In one embodiment, the spacing between adjacent apertures 64 corresponds to the minimal spacing distance which ensures a pressure of the pressurized fluid at the downstream or rear end of the bar 60 sufficient for removing debris. For example, the distance between two following apertures 64 is about 20 centimeters. It should be understood that the apertures 64 may be provided with any adequate shape. For example, the aperture 64 may be rounded, square, rectangular, and the like. In one embodiment, the aperture 64 is rounded and has a diameter comprised between about five millimeters and 15 millimeters.

While they are located on the front or upstream end 66 of the bar 60, it should be understood that the apertures 64 may have a different location. For example, the apertures may be located on at least one lateral side of the bar 60 between the front end 66 and the rear pointed end. In another embodiment, the bar 60 may be provided with apertures 64 on its front end 66 and on its two lateral sides so that pressurized fluid may be expelled from the front end 66 and the two lateral sides of the bar 60.

In one embodiment, the manifold 62 is in thermal communication with the upstream face 66 of the bars 60 and the pressurized fluid flowing into the manifold 62 of the bars 60 has a temperature adequate for preventing or minimizing frazil ice formation on at least the upstream face 66 of the bars 60 in order to prevent frazil ice from obstructing the apertures 64. For example, the pressurized fluid may be heated up to an adequate temperature before reaching the bars 60. A heater may be located within the pressurized fluid source 68 or along the distribution pipe 70 between the pressurized fluid source 68 and the first bar 60. For example, the heater may be located on the marine turbine assembly 10 and electrically connected to the electrical generator in order to use some of the electrical power generated by the marine turbine assembly 10 for heating the pressurized fluid.

The temperature of the pressurized fluid is chosen to at least reduce ice frazil formation of the front face of the bars 60 while propagating within the bar 60. For example, the temperature of the pressurized fluid may be chosen to maintain the temperature of the front end 66 of the bar 60 at a positive temperature. In another embodiment, the temperature of the pressurized fluid within the bar 60 is chosen to increase the temperature of the front end 66 of the bar 60 by a predetermined amount.

In one embodiment, a control unit (not shown) is used for controlling the pressure and/or temperature of the fluid flowing into the manifold 62 of each one of the bars 60. For example, the control unit may control a pump used for propagating the fluid into the manifold 62 and/or a valve adapted to regulate the flow of the fluid and/or the heater or heat exchanger used for heating the fluid propagating into the manifold 62, etc. It should be understood that pressure and/or temperature sensors may be used for monitoring the pressure and/or temperature of the fluid.

In one embodiment, the marine turbine assembly comprises at least one temperature sensor for measuring the temperature of the water surrounding the debris guard and the control unit is adapted to adjust the temperature of the fluid within the bar 60 as a function of the water temperature.

In one embodiment, the marine turbine assembly comprises at least one pressure/flow rate sensor for monitoring the pressure of the fluid within the bar 60. In this case, the control unit is further adapted to determine problems in the flow of pressurized fluid from the measured pressure or flow rate. For example, at least two pressure sensors may be positioned within the manifold 62 of each bar 60 at different locations along the length of the bar 60. The control unit monitors the difference between the pressure values measured by the at least two pressure sensors for each bar 60, and determines potential problems from variations of the pressure difference. For example, if the pressure difference between two pressure sensors located at different positions within and along a bar 60 increases, the control unit may determine that at least one aperture 64 is blocked by debris or frazil ice.

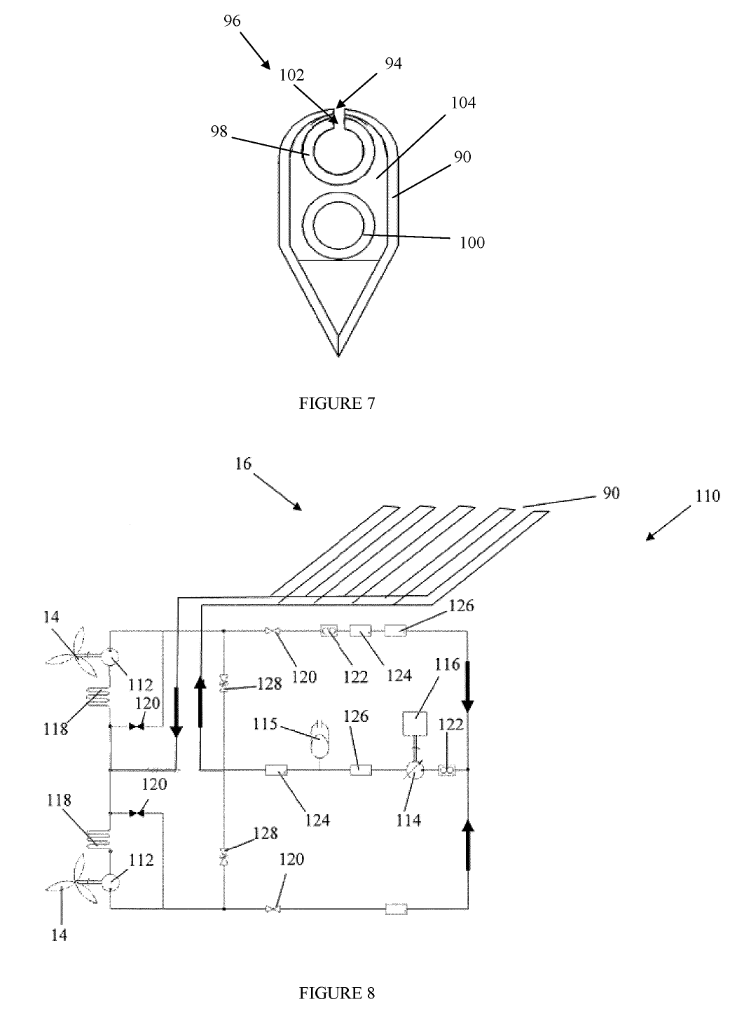

FIG. 7 illustrates one embodiment of a hollow bar 90 in which two different fluids propagate. The hollow bar 90 comprises an internal manifold 92 extending along at least a section of the length thereof and a plurality of apertures 94 located on the upstream side 96 of the bar 90. Two pipes 98 and 100 extend within the manifold 92. The pipe 98 is fluidly connected to a source of pressurized fluid and comprises a plurality of apertures 102 which each face a corresponding aperture 94 so the pressurized fluid flowing in to the pipe 98 may exit the bar 90 via apertures 94 and 102. The pipe 100 is in thermal communication with at least the upstream face 96 of the bar 90 and fluidly connected at one end to a source of warm fluid, i.e. a fluid whose temperature is adequate for preventing ice frazil formation on the bar 90. In one embodiment, the bar 90 comprises an aperture at the end opposite to the base 12 for expelling the fluid propagating in the pipe 100. Alternatively, the pipe 100 may be part of a closed-loop system in which the warm fluid circulates. In this case, the closed-loop system can comprise a pump and a heater fluidly connected to the pipes 100 of the bars 90. The pump is used to propagate the warm fluid into the closed loop system while the heater is used for heating the fluid up to a desired temperature. Once it has reached the end of the pipe 100 opposite to the base 12, i.e. the downstream end of the debris guard 16, the fluid is directed to the heater by the pump to be warmed-up up to the desired temperature before reaching a warm fluid distribution pipe to which the pipes 100 are fluidly connected and propagating in the pipes 100 of the bars 90. It should be understood that the pipes 100 may be fluidly connected to the warm fluid distribution pipe in adequate different ways. For example, the pipe 100 of each bar 90 may be directly connected to the warm fluid distribution fluid. In another example, only one pipe 100 is fluidly connected to the warm fluid distribution pipe and the other pipes 100 are fluidly connected in series to the pipe 100 fluidly connected to the distribution pipe.

In one embodiment, the space between the pipes 98 and 100 and the internal wall of the bar 90 is filled with a thermal conductive material, such as epoxy resin for example, for improving the exchange of heat between the pipe 100 and at least the upstream face 96 of the bar 90.

FIG. 8 illustrates one embodiment of a closed-loop warm fluid system in which a hydraulic fluid is used for preventing or minimizing frazil ice formation on the bars 90 of the debris guard 16 of a marine turbine assembly 110. The marine turbine assembly 110 comprises two turbines 14 each operatively connected to a hydraulic pump 112. The hydraulic pumps 112 are fluidly connected to a hydraulic engine 114 operatively connected to an electrical generator 116. The hydraulic fluid exiting the hydraulic pumps 112 flows up to the hydraulic engine 114 which cooperates with the electrical generator 116 for generating electrical energy. The hydraulic fluid is then sent to the debris guard 16 where it flows into the pipes 100 of the bars 90. While propagating in the pipes 100, the hydraulic fluid exchanges heat with at least the upstream end 96 of the bars 90, thereby warming-up the front face 96 of the bars 90 and at least minimizing ice frazil formation. Then the hydraulic fluid is directed to two heat exchangers 118 each located upstream to a respective hydraulic pump 112. The hydraulic fluid is warmed-up by the heat exchangers 118 and then propagates up to the hydraulic pumps 112 which are activated by their respective turbine 14. The hydraulic fluid then propagates back up to the hydraulic engine 114.

In one embodiment, a reservoir 115 containing hydraulic fluid is connected to the hydraulic fluid circuit for managing hydraulic flow variations.

The hydraulic system may further comprise valves as in 120, flow meters 122, pressure sensors 124, thermometers 126 in addition to a control unit adapted to control the flow and temperature of the hydraulic fluid. In one embodiment, the system 100 may further comprise safety or blowout valves for safety purposes.

In one embodiment, the hydraulic system further comprises a valve system controlled by the control unit for allowing the hydraulic fluid to bypass the debris guard 16 when no warming-up of the bars 90 is desired. In this case, the hydraulic fluid can directly propagate from the hydraulic engine 114 to the heat exchangers 118 without propagating in the bars 90 of the debris guard 16.

While in the present description it projects rearwards, from the front end 38 of the marine turbine assembly 10 towards the rear end 40, the debris guard 16 may alternatively project frontwards.

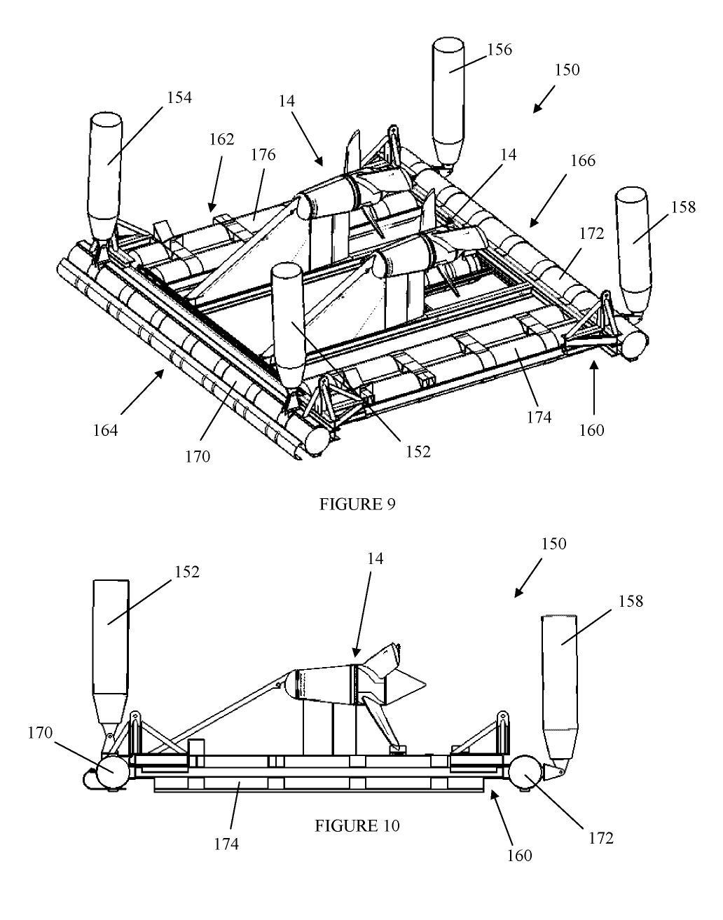

FIGS. 9 and 10 illustrate one embodiment of a marine turbine assembly 150 which comprises four elongated ballast tanks 152, 154, 156, and 158 for controlling the trim (i.e. the manner in which the marine turbine assembly 150 floats on water, in relation to its fore-and-aft line) and/or the buoyancy of the marine turbine assembly 150.

The marine turbine assembly 150 comprises a base 160 having a receiving top surface 162 and two turbines 14 secured on top of the receiving surface 162 of the base 160. The four elongated ballast tanks 152, 154, 156, and 158 are secured on top of the receiving surface 162 and extend substantially upwardly therefrom. The elongated ballast tanks 152 and 154 are located adjacent to the front or upstream end 164 of the base 160 and adjacent to opposite lateral sides of the base 160. The elongated ballast tanks 156 and 158 are located adjacent to the rear or downstream end 166 of the base 160 and adjacent to opposite lateral sides of the base 160.

The elongated ballast tanks 152, 154, 156, and 158 are each connectable to a source of pressurized gas (not shown), such as a source of pressurized air for example. The source of pressurized gas can be positioned on the base 160. Alternatively, the source of pressurized gas may be located outside of the marine turbine assembly 150. For example, the source of pressurized gas may be located on the bank of a river.

Each elongated ballast tank 152, 154, 156, and 158 is connected to a valve system (not shown) fluidly connected to the source of pressurized gas. Each valve system controls the entry and evacuation of water and pressurized gas for its respective elongated ballast tank 152, 154, 156, and 158, an aperture (not shown) comprising a single opening or alternatively an inlet separate from an outlet, as discussed herein above, being illustratively provided on each ballast tank 152, 154, 156, and 158 for enabling such entry and evacuation. A control unit (not shown) in communication with the valve systems is used for controlling the valve systems.

In one embodiment, the elongated ballast tanks 152, 154, 156, and 158 have a size adapted to contain an adequate quantity of pressurized gas for allowing the marine turbine assembly 150 to float near the water surface. By controlling the quantity of water and pressurized gas within the elongated ballast tanks 152, 154, 156, and 158, the buoyancy of the marine turbine assembly 150 can be adjusted. For example, the marine turbine assembly 150 may float by filling the elongated ballast tanks 152, 154, 156, and 158 entirely with pressurized gas while it may be deposited on the stream bed of a river, for example, by filling the ballast elongated ballast tanks 152, 154, 156, and 158 entirely with water from the river.

Furthermore, the trim of the base 160 can also be controlled by controlling the quantity of water and pressurized gas within each elongated ballast tanks 152, 154, 156, and 158. Since they extend upwardly from the base 160, the elongated ballast tanks 152, 154, 156, and 158 allow for a precise control of the trim of the marine turbine assembly 150.

In another embodiment, the base 160 of the marine turbine assembly 150 further comprises an upstream ballast compartment 170, a downstream ballast compartment 172, and two lateral ballast compartments 174 and 176. Again, the ballast compartments 170, 172, 174, and 176 may be coupled to the frame (not shown) of the base 160 using any suitable means, such as by attachment thereto or insertion therein. Also, the ballast compartments 170, 172, 174, and 176 may form a single unit or separate and independent units, as discussed herein above.

The ballast compartments 170, 172, 174, and 176 are all connectable to the source of pressurized gas. In this case, the internal volume of the elongated ballast tanks 152, 154, 156, and 158 may be less than that of the previous embodiment since the compartments 170, 172, 174, and 176 also contribute to the buoyancy of the marine turbine assembly 150.

Each ballast compartment 170, 172, 174, and 176 is provided with a valve system fluidly connected to the source of pressurized gas. Each valve system controls the entry and evacuation of water and pressurized gas for its respective ballast compartment 170, 172, 174, and 176, an aperture (not shown) being illustratively provided on each ballast compartment 170, 172, 174, and 176 for enabling such entry and evacuation. The buoyancy of the marine turbine assembly 150 is mainly controlled by the ballast compartments 170, 172, 174, and 176 while the trim of the marine turbine 150 is mainly adjusted via the elongated ballast tanks 152, 154, 156, and 158. For example, during initial immersion of the turbine assembly, as in 150, the valve system of the upstream ballast compartment 170 may be used to gradually fill the ballast compartment 170 with water. The valve system of the downstream ballast compartment 172 may then be used to fill the ballast compartment 172 with water. As a result, the marine turbine assembly 150 can be steadily immersed with the upstream end 164 and the downstream end 166 of the base 160 at the same underwater depth, i.e. the marine turbine assembly 150 remaining horizontal throughout the process. Illustratively, in order to further maintain longitudinal stability once the marine turbine assembly 150 reaches the stream bed of a river, the entire volume of the upstream ballast compartment 170 may be filled with water, followed by that of the downstream ballast compartment 172. Cylindrical ballast tanks, as in 152, 154, 156, and 158, having a one meter diameter and a five meter length may be further used to mainly control the trim of the submersible base 160, having ballast while also helping in controlling the buoyancy of the turbine assembly 150.

In one embodiment, the elongated ballast tanks 152, 154, 156, and 158 are movable with respect to the base 160. For example, the elongated ballast tanks 152, 154, 156, and 158 may be pivotally or rotatably secured to the base 160 so that the angle between the longitudinal axis of the ballast tank and the plane of the base 160 is adjustable. In this case, a motorized mechanical connection allowing a rotatable or pivotal motion connects the elongated ballast tanks 152, 154, 156, and 158 to the base 160. The control unit then controls the motor of the motorized mechanical connection for moving the elongated ballast tanks 152, 154, 156, and 158 with respect to the base 160 in order to adjust the angle between the elongated ballast tanks 152, 154, 156, and 158 and the plane of the base 160 to a desired value.

The pivotal or rotational motion of the elongated ballast tanks 152, 154, 156, and 158 allows for a better control of the trim of the marine turbine assembly 150. For example, while diving, the marine turbine assembly 150 may be inclined, e.g. the underwater depth of the upstream end 164 may be greater than that of the downstream end 166, and the elongated ballast tanks 152, 154, 156, and 158 may be moved so as to substantially constantly extend vertically during the diving of the marine turbine assembly 150. In particular, with the marine turbine assembly 150 thus inclined, the upstream ballast tanks 152 and 154 may be pivoted towards the downstream end 166 of the base 160 by an angle (not shown) while the longitudinal axis of the downstream ballast tanks 156 and 158 remains substantially perpendicular to the plane of the base 160. In this manner, immersion of the upstream ballast tanks 152 and 154 increases while diving whereas immersion of the downstream ballast tanks 156 and 158 decreases. An additional stabilizing moment, i.e. a set of forces that stabilizes the marine turbine assembly 150, is thus achieved.

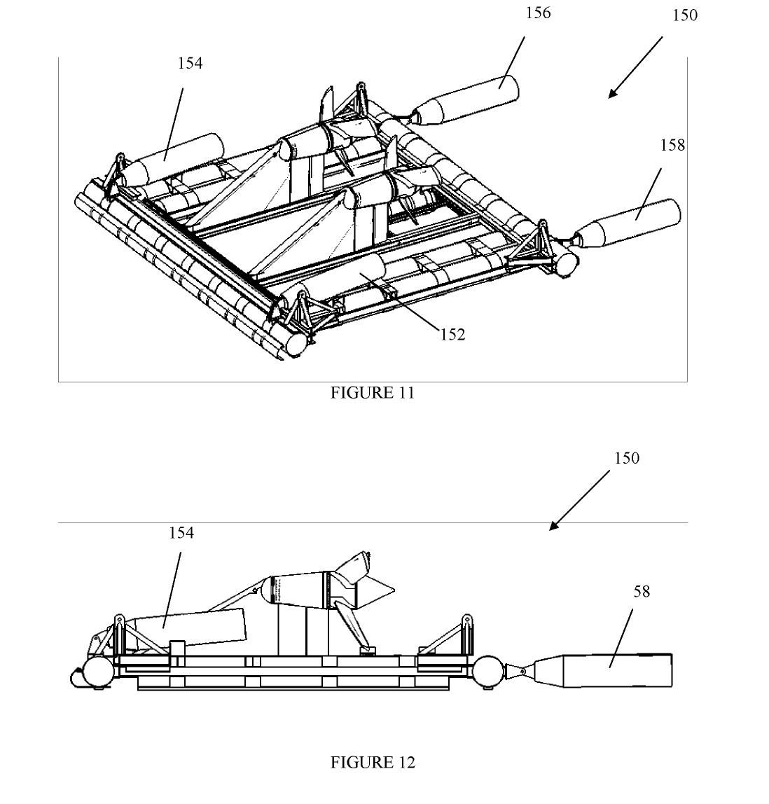

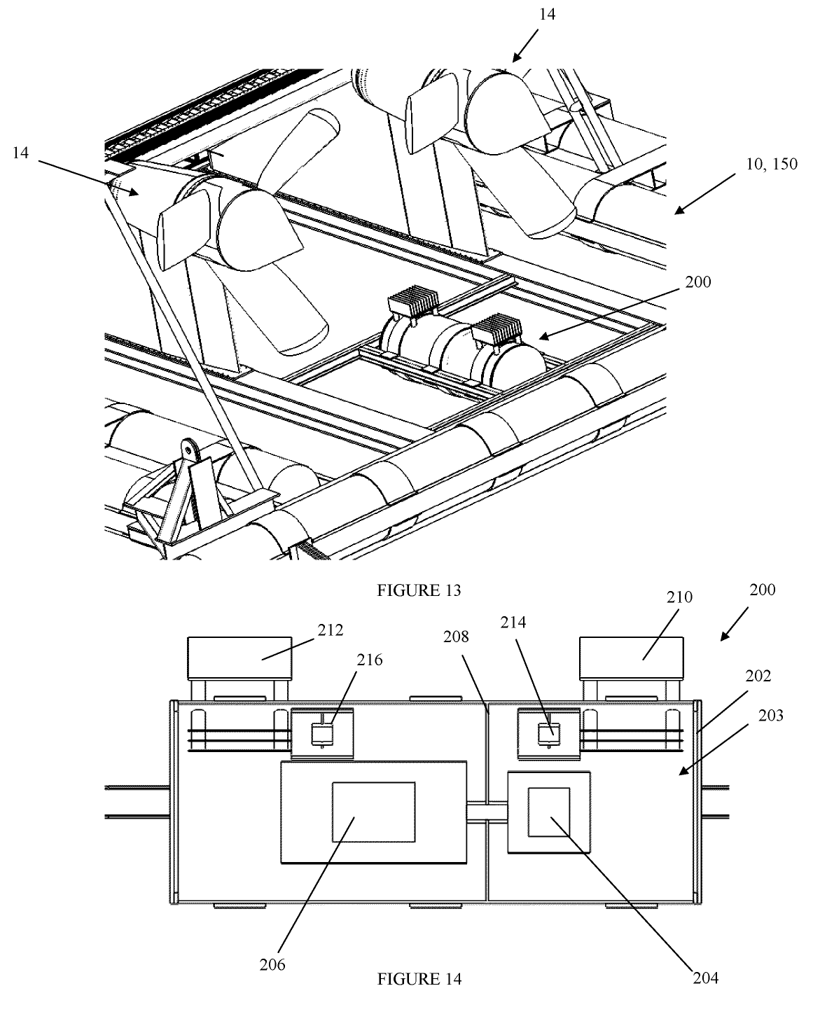

In one embodiment, the elongated ballast tanks 152, 154, 156, and 158 are positioned in a rest or laying position when the marine turbine assembly is deposited on the stream bed of a river, for example, for preventing debris from holding thereon, as illustrated in FIGS. 11 and 12. In this position, the upstream ballast tanks 152 and 154 rest on the base 160 while the downstream ballast tanks 156 and 158 lay on the stream bed of a river.

It should be understood that the location of the elongated ballast tanks 152, 154, 156, and 158 within the marine turbine assembly 150 is exemplary only. For example, the elongated ballast tanks 152, 154, 156, and 158 may extend from the lateral sides of the base 160.

While the present description refers to four elongated ballast tanks 152, 154, 156, and 158, it should be understood that the number of elongated ballast tanks may vary as long as the marine turbine assembly 150 comprises at least three elongated ballast tanks and the three elongated ballast tanks are not aligned, i.e. the centers of the three elongated ballast tanks form a triangle.

Similarly and as discussed herein above with respect to FIGS. 1 to 3, it should also be understood that although the present description refers to four ballast compartments 170, 172, 174, and 176, the number of ballast compartments may vary as long as they ensure that the marine turbine assembly 150 is adequately balanced and stable on the water. For this purpose, two identical ballast compartments may be provided on opposite ends of the illustratively rectangular base 160. For instance, only the upstream and downstream ballast compartments 170 and 172 or alternatively only the two lateral ballast compartments 176 and 174 may be provided. Still, providing four ballast compartments as in 170, 172, 17, and 176 along the perimeter of the base 160 enables a more precise control of the buoyancy of the overall marine turbine assembly 150.

While the elongated ballast tanks 152, 154, 156, and 158 and the ballast compartments 170, 172, 174, and 176 are provided with a substantially cylindrical cross-sectional shape, the skilled person would understand that other adequate shapes are possible. For example, the cross-section of an elongated ballast tank as in 152 or of a ballast compartment as in 170 along its longitudinal axis may have a rectangular, oval, or the like shape. In an embodiment, an electrical generator is secured onto the marine turbine assembly 10, 150. Referring to FIGS. 13 and 14, there is shown a power assembly 200 secured to the marine turbine assembly 10, 150 between the two turbines. As illustrated in FIG. 14, the power assembly 200 comprises a frame 202 comprising an internal chamber 203 in which a hydraulic engine 204 and an electrical generator are enclosed. A wall 208 divides the internal chamber 203 into two sections each receiving a respective one of the hydraulic engine 204 and the electrical generator 206. The hydraulic engine 204 is fluidly connected to the hydraulic pumps operatively connected to the turbines 14 for receiving a hydraulic fluid therefrom.

The power assembly 200 further comprises two heat exchangers 210 and 212 each extending partially within a respective section of the chamber 203 and partially outside of the frame 202. It should be understood that the heat exchangers 210 and 12 are substantially hermetically secured to the frame 202 so that no water may leak into the chamber 203. The heat exchanger 210 is adapted to evacuate heat generated by the hydraulic engine 204 outside of the section of the chamber 203 containing the hydraulic engine 204. The heat exchanger 212 is adapted to evacuate heat generated by the electrical generator 206 outside of the section of the chamber 203 containing the electrical generator 206.

In one embodiment, the power assembly 200 further comprises two fans 214 and 216 for improving the cooling of the power assembly 200 by circulating air within their respective section of the chamber 203. The fan 214 is located in the section of the chamber 203 containing the hydraulic engine 204 for circulating air inside this section. The fan 216 is located in the section of the chamber 203 containing the electrical generator 206 for circulating air inside this section.

While the hydraulic engine 204 and the electrical generator 206 are each provided with a respective chamber section, it should be understood that the wall 208 may be omitted. In this case, the power assembly may comprise a single heat exchanger and/or a single fan.

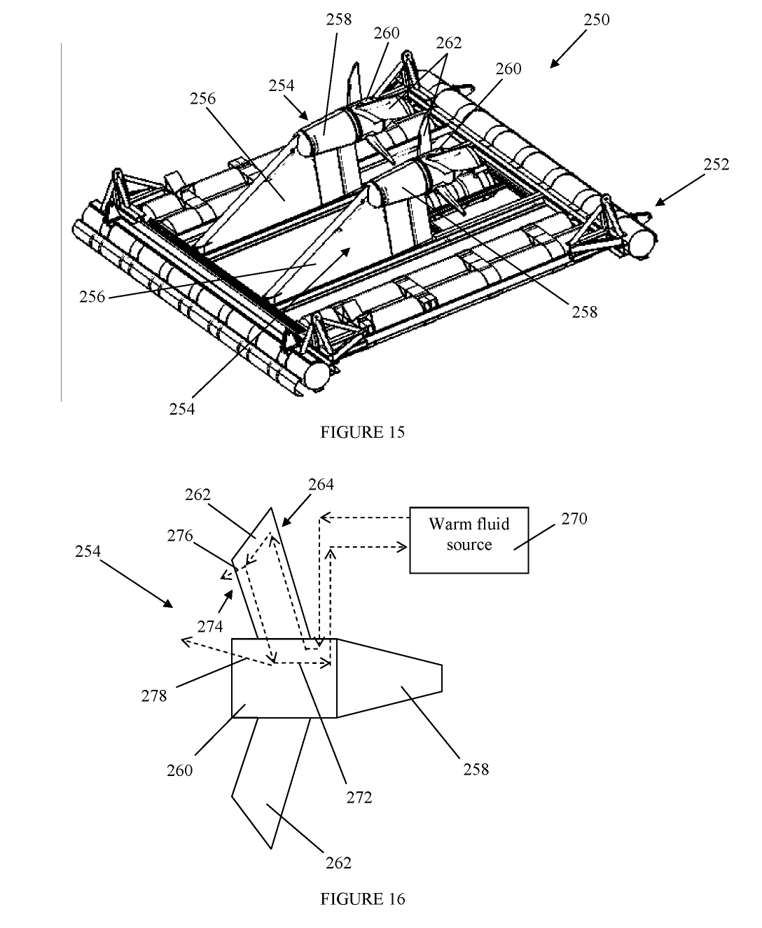

FIG. 15 illustrates one embodiment of a marine turbine assembly 250 comprising a submersible base 252 having a top receiving surface on which two turbines 254 having de-icing blades are secured. Each turbine 254 comprises a support 256 extending from the base 252, a nacelle 258 secured to the support 256, a rotor 260 rotatably secured to the nacelle 258, and a plurality of de-icing blades 262 projecting from the rotor 260. Each blade 262 is provided with an internal manifold (not shown) extending adjacently along its leading edge. Each manifold is in thermal communication with its respective leading edge so that a heat exchange may occur when a warm fluid flows within the manifold.

FIG. 16 schematically illustrates the flow of fluid which propagates within the manifold adjacent to the leading edge 264 of a blade 262. The manifold extending along the leading edge of a blade is referred to as a leading edge manifold hereinafter.

The leading edge manifold is fluidly connected to a source 270 of warm fluid, such as warm air or warm water for example, through the rotor 260 of the turbine 254. The warm fluid source 270 can comprise a pump for propagating the fluid up to the leading edge manifold and a heating device for heating the fluid up to a desired temperature. The temperature of the fluid is chosen so that, when flowing in the leading edge manifold, the fluid may transfer heat to the leading edge 264 of the blade 262 in order to prevent or minimize the formation of frazil ice on the leading edge 264.

In one embodiment, the flow of warm fluid operates according to a closed-loop configuration. In this case, the fluid flows from the warm fluid source 270 up to the leading edge manifold where a heat transfer occurs in order to heat the leading edge 264 of the blade 262 and therefore prevent any frazil ice formation. After propagating along the leading edge and transferring heat thereto, the fluid flows back into the rotor 260 where it is directed back to the warm fluid source 270, as illustrated by arrow 272, in order to be heated and propagated back into the leading edge manifold.

In another embodiment, the fluid is evacuated in the surrounding environment of the turbine 254 after propagating in the leading edge manifold. For example, the fluid may be evacuated via an aperture located in the rear end 274 of the blade 262, as illustrated by arrow 276. In another example, the fluid propagates back to the rotor 260 and exits the rotor 260 via an aperture located at the rear end of the rotor 260 as illustrated by arrow 278.

It should be understood that a control unit in communication with the warm fluid source 270 may be used for controlling the characteristics of the warm fluid such as its pressure, flow rate, temperature, and the like. For example, the control unit may control the pump used for propagating the fluid or a valve in order to adjust the pressure or flow rate of the warm fluid to a desired value. The control unit may also control a heating device used for heating the fluid up to desired temperature.

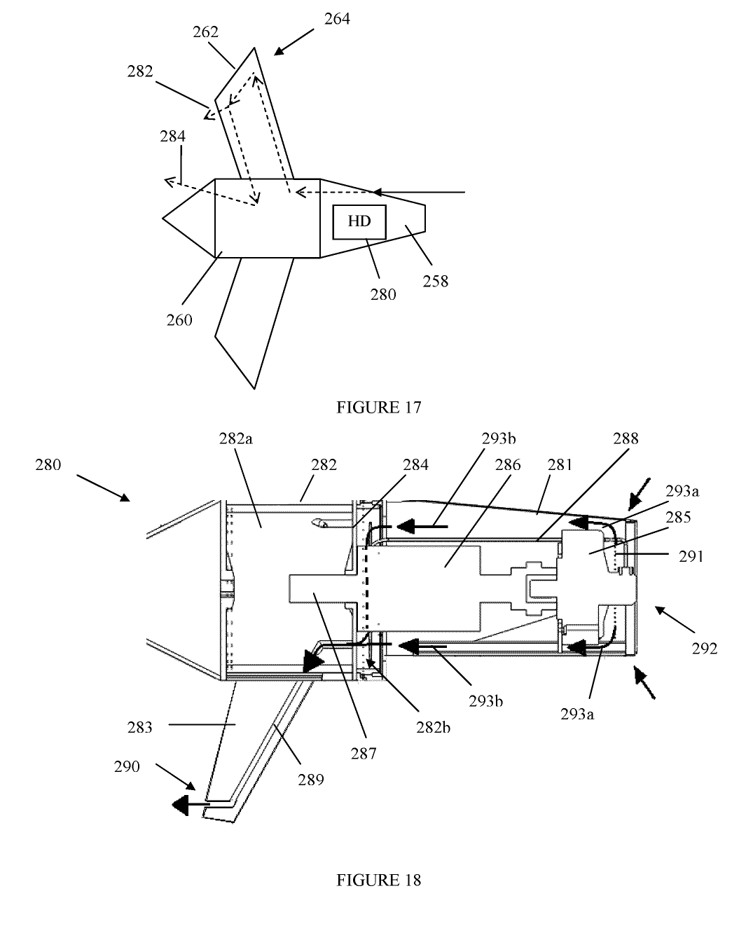

FIG. 17 schematically illustrates one embodiment of the flow of water used for preventing or minimizing frazil ice formation on the leading edge 264 of a blade 262. The nacelle 258 comprises at least one aperture by which water surrounding the nacelle 258 may flow when the marine turbine assembly 250 is immersed in water. The marine turbine assembly is positioned such that its front end faces the water current.

The aperture of the nacelle 258 is fluidly connected to the leading edge manifold of the blades 262. A heating device 280 is located within the nacelle 280 and the flow of water coming from the aperture in the nacelle 258 is in thermal communication with the heating device 280. While propagating through the nacelle 258, the water is heated before reaching the leading edge manifold of the blades 262. It should be understood that the heating device 280 may be any device which generates heat. For example, the heating device 280 can comprise a hydraulic pump, an electrical generator, a gear box, and/or the like. It should also be understood that at least one heat exchanger may be used for transferring heat from the heating device 280 to the water flowing into the nacelle 258. It should also be understood that any adequate fluidic connection in thermal communication with the heating device 280 may used for transporting the water from the aperture in the nacelle 258 up to the leading edge manifold. For example, at least one pipe can fluidly connect the aperture(s) in the nacelle 258 to the leading edge manifolds extending in the blades 262.

Water enters the nacelle 258 via the aperture present at the front end thereof. The rotation of the blades 262 generates a depression zone at the rear end of the turbine 254, which creates a suction force which helps aspiring water from the nacelle 258 where water is warmed up by the heating device 280 into the manifold extending along the leading edge of the blade 262. As a result, water flows into the leading edge manifold of the blade 262 where heat is transferred from the fluid to the leading edge 264. The leading edge manifold can be fluidly connected to an aperture on the rear end of the blade 262 within the depression zone of the blade 262. In this case, after propagating in the leading edge manifold, the water is evacuated by this aperture, as illustrated by arrow 282. Alternatively, the leading edge manifold can be fluidly connected to an aperture at the rear end of the rotor 260. In this case, after propagating in the leading edge manifold, the water is evacuated by this aperture, as illustrated by arrow 284.

When an aperture is present at the rear end of the blades 262, the depression generated by the rotation of the rotor 260 generates a depression behind the rear end 274 of the blades 262. The depression creates a suction force which helps aspiring water into the aperture at the front of the nacelle 258.

It should be understood that a control unit may be used to control some characteristics of the warm fluid such as its temperature or its flow rate or pressure. In this case, the control unit may control a pump used to propagate the warm fluid, a valve for adjusting the flow rate or pressure, a heater for adjusting the fluid temperature, and the like.

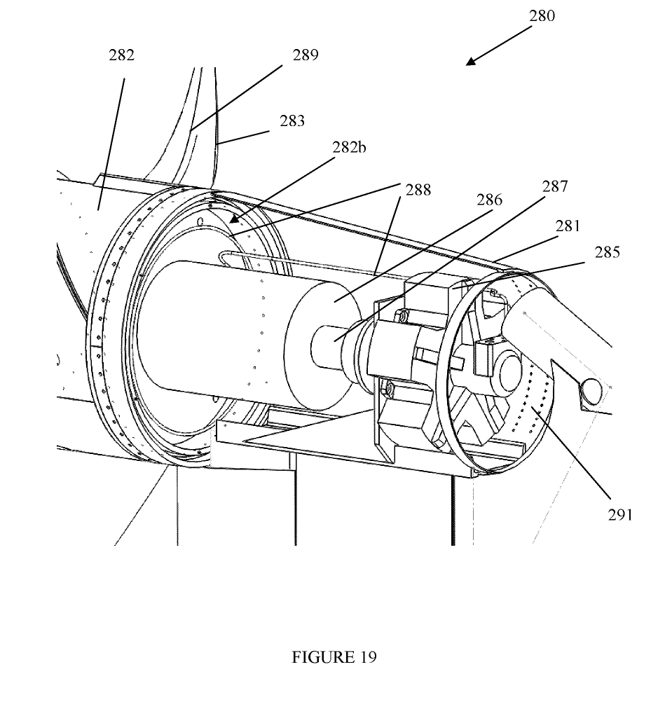

FIGS. 18-20 illustrates one embodiment of a turbine 280 adapted to use surrounding water to prevent or minimize ice frazil formation at least on the leading edge of blades. The turbine 280 comprises a nacelle 281, a rotor 282, and a plurality of blades 283 projecting from the rotor 282. A wall 284 divides the rotor 282 into two sections, a drum 282a and a chamber 282b. The chamber 282b is fluidly connected to the nacelle 281 so that water may flow from the nacelle 281 to the chamber 282b of the rotor 282.

The turbine 280 further comprises a hydraulic pump 285 located within the nacelle 281 and a gear box 286 extending partially in the chamber 282b and partially in the nacelle 281. The turbine 280 also comprises a shaft 287 extending from the drum 282a to the hydraulic pump 285 through the gear box 286 for operatively connecting the rotor 282 to the hydraulic pump 285 so that rotation of the rotor 282 drives the hydraulic pump 285.

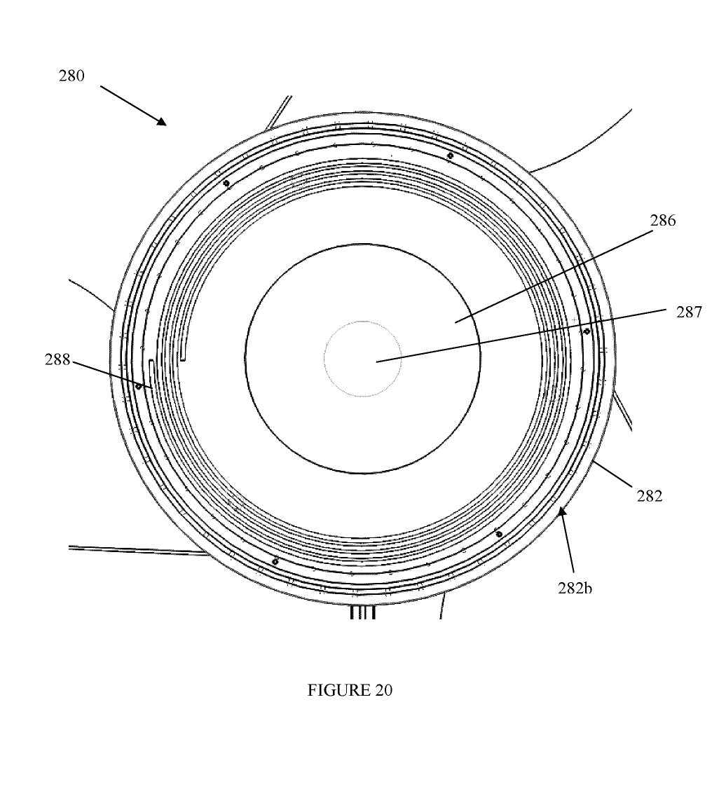

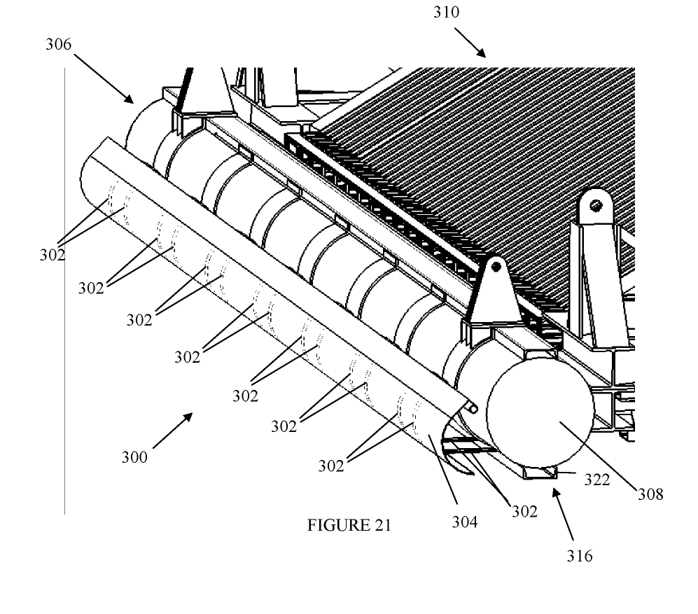

A hydraulic pipe 288 adapted to transport a hydraulic fluid fluidly connects the hydraulic pump 285 to a hydraulic engine (not shown) operatively connected to an electrical generator (not shown) to convert the rotational motion of the rotor 282 into electricity. The pipe 288 extends through the nacelle 281 up to the chamber 282b of the rotor 282 where it is winded up around the gear box 286 as illustrated in FIG. 20.

Each blade 283 is provided with a manifold 289 extending adjacently along the leading edge thereof. Each blade 283 is further provided with an aperture 290 on the rear or downstream side of the blade 283 and the manifold 289 is fluidly connected to the aperture 290.

The nacelle 281 is further provided with apertures 291 circumferentially located on its lateral surface adjacent to its front or upstream end 292. It should be understood that the apertures 291 may be located at any adequate location on the nacelle 281 as long as they allow water to flow into the nacelle 281. For example, the apertures 291 may be located on the front face of the nacelle 281.

When the turbine 280 is immerged, water flows into the nacelle 281 and the chamber 282b of the rotor 282 via the apertures 291, as illustrated by arrows 293a and 293b in FIG. 18. The rotation of the rotor 282 drives the hydraulic pump 285 which propagates a warm hydraulic fluid into the hydraulic pipe 288. Since the water contained in the nacelle 281 and the chamber 282b is in thermal communication with the hydraulic pipe 288, the warm hydraulic fluid flowing into the hydraulic pipe 288 transfers heat to the water which is warmed-up.

Furthermore, the rotation of the rotor 282 generates a depression zone on the rear side of the blades 283. The depression creates a suction force which draws the warmed-up water contained in the chamber 282b into the manifold 289 before exiting the blade 283 via the aperture 290. Since the manifold 289 is in thermal communication with the leading edge of the blade 283, the propagation of the warm water in the manifold 289 allows the leading edge of the blade 283 to be heated and therefore prevents or minimizes the formation of frazil ice thereon.

The temperature of the fluid used for heating the leading edge of the blades is chosen to at least reduce ice frazil formation on the leading edge of the blades while propagating within the leading edge manifold. For example, the temperature of the fluid may be chosen to maintain the temperature of the leading edge of the blades at a positive temperature. In another embodiment, the temperature of the fluid is chosen to increase the temperature of the leading edge of the blades by a predetermined amount.

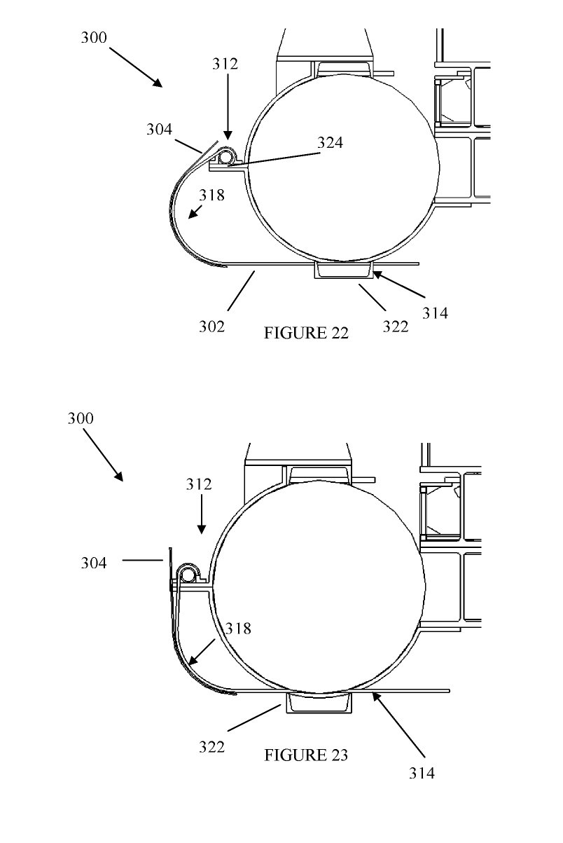

FIGS. 22 and 23 illustrate one embodiment of a bumper or shock-absorbing assembly 300 for a submersible marine turbine assembly such as marine turbine assembly 10, 150, or 250 for example. The bumper assembly 300 is used for absorbing some of an impact when the front end of the marine turbine assembly collides with an object or with the stream bed of a river, for example.

The bumper assembly 300 comprises a plurality of U-shaped plates 302 and a curved protection plate 304. The U-shaped plates 302 are secured to the front end 306 of the base 308 of the marine turbine assembly 310. The U-shaped plates are spaced along the length of the front end 306 of the base 308. Each U-shaped plate 302 has one end portion 312 rotatably secured to the front end 306 of the base 308 and another substantially linear or straight end portion 314 slidably secured to the bottom surface 316 of the base 308. The U-shaped plate 302 further comprises a curved or rounded portion 318 between the two end portions 312 and 314. The curved portion 318 projects frontwards from the front end 306 of the base 308.

The curved protection plate 304 extends along substantially the whole length of the front end 306 of the base 308 and is fixedly secured to each U-shaped plate 302. As illustrated in FIG. 23, the protection plate 304 is secured to the curved portion 318 of each U-shaped plate 302, so that the curvature of the protection plate 304 substantially corresponds to that of the curved portion 318 of the U-shaped plate 302.

A U-shaped securing plate 322 is secured to the bottom end 316 of the base 308 adjacent to the front end 306 thereof. The securing plate 322 extends along substantially the whole length of the front end 306 of the base 308 and comprises a plurality of recesses on its front and rear ends which are secured to the base 308. Each recess of the front end of the securing plate 322, i.e. each front recess, is aligned with a respective recess of the rear end of the securing plate 322, i.e. a respective rear recess. The end portion 314 of each plate 302 is inserted into respective front and rear recesses of the securing plate 322 between the base 308 and the securing plate 322. As a result, the end portion 314 may slide with its respective recesses, being therefore slidably secured to the base 308 of the marine turbine assembly 310.

It should be understood that any adequate mechanical connection which allows to slidably secure the end portion 314 of a U-shaped plate 302 to the base 308 may be used. For example, the base 308 may comprise a plurality of recesses each extending from its front end 306 towards its rear end adjacent to the bottom end 316 of the base 308. Each recess is then configured to receive the end portion 314 of a respective U-shaped plate 302.

The characteristics of the U-shaped plates 302 and the protecting plate 304, including the material from which they are made, their thickness, and the like, are chosen so that they are substantially elastically deformable. For example, the plates 302 may be made from steel or steel embedded in a rubber sleeve. FIG. 24 illustrates the bumper assembly 300 during an impact with an object which causes the bumper assembly 300 to elastically deform. During an impact with an object, the U-shaped plate 302 rotates about the axis of the end portion 312 rotatably secured to the front end 306 of the base 308, the central curved portion 318 is elastically deformed, i.e. the curvature radius of the curved portion 318 increases, and the end portion 314 slides with respect to the base 308 towards the rear end of the base 308. The protection plate 304 follows substantially the same elastic deformation as that of the curved portion 318 of the U-shaped plates 302, i.e. its curvature radius increases. It should be understood that only one or some of the U-shaped plates 302 may experience an elastic deformation during a collision.

While the rotatable end portion 312 of the U-shaped plate 302 is secured on top of a protrusion 324 protruding from the front end 306 of the base 308 and the curved portion 318 projects downwardly therefrom, other adequate configurations are possible. For example, the curved portion 318 may project upwardly from the rotatable end portion 312 and the straight end portion 314 may be slidably secured to the top end of the base 308. In this case, the rotatable end portion 312 may be rotatably secured to the bottom surface of the protrusion 324 and the securing plate 322 may be secured to the top surface of the base 308.

While it is made from a single piece, it should be understood that the protecting plate 304 may be made from a plurality of segments.

While the present description refers to a planar and rectangular base for a marine turbine assembly, the skilled person will understand that the base may be provided with any adequate shape allowing to receive at least one turbine, a debris guard, a bumper assembly, and/or the like. While in the present description, it is submersible, i.e. provided with ballast compartments for controlling the buoyancy of the marine turbine assembly, it should be understood that the base may not be capable of floating as long as the weight of the base is sufficient for allowing the marine turbine assembly to be deposited on the stream bed of a river for example. In this case, cables secured to the base may be used for immersing the marine turbine assembly in water.

When a control unit is used for controlling the marine turbine assembly, any adequate communication means between the control unit and the marine turbine assembly may be used. For example, at least one communication power line may connect the control unit to the marine turbine assembly. Alternatively, wireless communication such as ultrasound communication may be used.

While the present description refers to two turbines, it should be understood that the number of turbines may vary as long as the marine turbine assembly comprises at least one turbine. It should also be understood that at least one electrical generator may be located on the marine turbine assembly. Alternatively, the electrical generator may be located outside of the marine turbine assembly, such as on the bank of a river for example. In this case, the rotor of each turbine can be operatively connected to a hydraulic pump which is also operatively connected to an electrical generator, such as the electrical generator located on the bank of the river. It should also be understood that each turbine may be operatively coupled with a respective electrical generator. Alternatively, at least two turbines may be operatively connected to a same electrical generator. When at least one electrical generator is comprised in the marine turbine assembly, it should be understood that the at least one electrical generator may be located at any adequate location such as in the nacelle of a turbine, on the base between two turbines, etc.

In one embodiment, an anchorage system is used for anchoring the marine turbine assembly to the stream bed of the river. It should be understood that any adequate anchoring system may be used.

The embodiments described above are intended to be exemplary only. The scope of the invention is therefore intended to be limited solely by the scope of the appended claims.

1. A marine turbine assembly comprising:
a frame having a receiving surface;
at least one turbine mounted to the receiving surface of the frame and comprising a rotor and a plurality of blades projecting therefrom, the rotor being operatively connectable to an electrical generator for generating electrical energy from a water current; and
a ballast system coupled to the frame and balancedly distributed around a perimeter thereof, the ballast system having at least one compartment with at least one aperture for selectively receiving and selectively expelling pressurized fluid from a source of pressurized fluid, thereby controlling at least one of a trim and a buoyancy of the marine turbine assembly.

2. The marine turbine assembly of claim 1, wherein the ballast system comprises a valve system fluidly connectable to the source of pressurized fluid for selectively receiving and selectively expelling the pressurized fluid.

3. The marine turbine assembly of claim 1, wherein the at least one aperture comprises a first aperture for selectively receiving the pressurized fluid and a second aperture for selectively expelling the pressurized fluid.

4. The marine turbine assembly of claim 1, wherein the at least one compartment comprises a plurality of independent ballast compartments extending along the perimeter of the frame for selectively receiving and selectively expelling the pressurized fluid, thereby controlling the buoyancy.

5. The marine turbine assembly of claim 4, wherein the plurality of ballast compartments comprises two front ballast compartments positioned adjacent an upstream end of the frame and two rear ballast compartments positioned adjacent a downstream end of the frame.

6. The marine turbine assembly of claim 1, wherein the at least one compartment comprises at least three elongated ballast tanks upwardly projecting from the receiving surface of the frame for selectively receiving and selectively expelling the pressurized fluid, thereby controlling the at least one of a trim and a buoyancy.

7. The marine turbine assembly of claim 6, wherein the at least three ballast tanks comprise two front ballast tanks positioned adjacent an upstream end of the frame and two rear ballast tanks positioned adjacent a downstream end of the frame.

8. The marine turbine assembly of claim 6, wherein the at least three ballast tanks are one of rotatably and pivotally secured to the frame for controlling the trim.

9. The marine turbine assembly of claim 1, further comprising a debris guard secured to the frame between an upstream end thereof and the turbine and projecting from the receiving surface for protecting the turbine from debris.

10. The marine turbine assembly of claim 9, wherein the debris guard comprises a plurality of spaced apart bars.

11. The marine turbine assembly of claim 10, wherein each one of the bars comprises an internal manifold extending along at least a section thereof and is provided with a plurality of apertures fluidly connected to the internal manifold on an upstream surface thereof, the internal manifold being fluidly connectable to the source of pressurized fluid for propagating the pressurized fluid into the manifold and expelling the pressurized fluid via the apertures in order to remove the debris from the debris guard.

12. The marine turbine assembly of claim 1, wherein each one of the blades has an internal manifold extending along at least a section of a leading edge thereof and in thermal communication with the leading edge, the internal manifold being fluidly connectable to a source of warm fluid for propagating the warm fluid therein in order to at least reduce ice frazil formation on the leading edge of the blades.

13. The marine turbine assembly of claim 12, wherein the turbine further comprises a nacelle positioned upstream to the rotor and a gear box located in the nacelle, the gear box operatively connected to the rotor, the nacelle comprising at least one input opening fluidly connected to the manifold via a fluidic connection, the fluidic connection being in thermal communication with the gear box, wherein upon rotation of the rotor, the gear box is activated and generates heat, and a depression region is created by the blades which causes water to enter the fluidic connection via the input opening and propagate in the manifold, the water being warmed up by the heat generated by the gear box.

14. The marine turbine assembly of claim 13, wherein the blades each comprise an output opening adjacent to an end of the leading edge and fluidly connected to the manifold for expelling the water from the manifold.

15. The marine turbine assembly of claim 13, wherein the turbine comprises at least one of an electrical generator and a hydraulic pump operatively connected to the electrical generator, each located within the nacelle, operatively connected to the gear box and in thermal communication with the fluidic connection for warming up the water propagating therein.

16. The marine turbine assembly of claim 1, further comprising a shock-absorbing device projecting frontwards from a front end of the frame and comprising a plurality of substantially U-shaped plates and a protection plate, each of the substantially U-shaped plates having a first end portion rotatably secured to the front end of the frame, a second end portion slidably secured to the frame, and a curved portion therebetween, the protection plate being secured to the curved portion of each U-shaped plate, each U-shaped plate and the protection plate being elastically deformable so that, upon collision of the protection plate with an object, at least one of the U-shaped plate rotates about an axis of the first end portion and the second end portion slides with respect to the frame in order to absorb at least part of an impact caused by the collision.

17. A ballast system for use with a marine turbine assembly having a frame, the ballast system comprising a body adapted to be coupled to the frame and balancedly distributed around a perimeter thereof; the body having at least one compartment with at least one aperture for selectively receiving and selectively expelling pressurized fluid from a source of pressurized fluid, thereby controlling at least one of a trim and a buoyancy of the marine turbine assembly.

18. The ballast system of claim 17, further comprising a valve system fluidly connected to the source of pressurized fluid for selectively receiving and selectively expelling the pressurized fluid.

19. The ballast system of claim 17, wherein the at least one aperture comprises a first aperture for selectively receiving the pressurized fluid and a second aperture for selectively expelling the pressurized fluid.

20. The ballast system of claim 17, wherein the body is shaped to substantially match a shape of the frame, and the at least one compartment comprises a plurality of independent ballast compartments extending along a perimeter of the body for selectively receiving and selectively expelling the pressurized fluid, thereby controlling the buoyancy.

21. The ballast system of claim 19, wherein the plurality of ballast compartments comprises two front ballast compartments positioned adjacent an upstream end of the body and two rear ballast compartments positioned adjacent a downstream end of the body.

22. The ballast system of claim 17, wherein the at least one compartment comprises at least three elongated ballast tanks extending away from the body for selectively receiving and selectively expelling the pressurized fluid, thereby controlling the at least one of a trim and a buoyancy.

23. The ballast system of claim 22, wherein the at least three ballast tanks comprise two front ballast tanks positioned adjacent an upstream end of the body and two rear ballast tanks positioned adjacent a downstream end of the body.

24. The ballast system of claim 22, wherein the at least three ballast tanks project upwardly from the body.

25. The ballast system of claim 22, wherein the at least three ballast tanks are one of rotatably and pivotally secured to the body for controlling the trim.

26. A marine turbine assembly comprising:
a frame having a receiving surface and a front end;
at least one turbine mounted to the receiving surface of the frame and comprising a rotor and a plurality of blades projecting therefrom, the rotor being operatively connectable to an electrical generator for generating electrical energy from a water current; and
a debris guard secured to the frame between the front end of the frame and the turbine and projecting from the receiving surface of the frame for protecting the turbine from debris.

27. The marine turbine assembly of claim 26, wherein the debris guard comprises a plurality of spaced apart bars.

28. The marine turbine assembly of claim 27, wherein each one of the bars comprises an internal manifold extending along at least a section thereof and provided with a plurality of apertures fluidly connected to the internal manifold on an upstream surface thereof, the internal manifold being fluidly connectable to a source of pressurized fluid for propagating the pressurized fluid into the manifold and expelling the pressurized fluid via the apertures in order to remove the debris from the debris guard.

29. The marine turbine assembly of claim 26, wherein the debris guard comprises a distribution pipe extending from the front end towards a back end of the frame, the distribution pipe being fluidly connectable to a source of pressurized fluid and having a plurality of apertures on an upper surface thereof for upwardly releasing at least part of the pressurized fluid received therein.

30. The marine turbine assembly of claim 26, further comprising a shock-absorbing device projecting frontwards from the front end of the frame and comprising a plurality of substantially U-shaped plates and a protection plate, each of the substantially U-shaped plates having a first end portion rotatably secured to the front end of the frame, a second end portion slidably secured to the frame, and a curved portion therebetween, the protection plate being secured to the curved portion of each U-shaped plate, each U-shaped plate and the protection plate being elastically deformable so that, upon collision of the protection plate with an object, at least one of the U-shaped plate rotates about an axis of the first end portion and the second end portion slides with respect to the frame in order to absorb at least some of an impact caused by the collision.

31. A marine turbine assembly comprising:
a frame having a receiving surface;
at least one turbine mounted to the receiving surface of the frame, the turbine comprising a rotor and a plurality of blades projecting therefrom, the rotor being operatively connectable to an electrical generator for generating electrical energy from a water current, each one of the blades having an internal manifold extending along at least a section of a leading edge thereof and in thermal communication with the leading edge, the internal manifold being fluidly connectable to a source of warm fluid for propagating the warm fluid therein in order to at least reduce ice frazil formation on the leading edge of the blades.

32. The marine turbine assembly of claim 31, wherein the turbine further comprises a nacelle positioned upstream to the rotor and a gear box located in the nacelle, the gear box operatively connected to the rotor, the nacelle comprising at least one input opening fluidly connected to the manifold via a fluidic connection, the fluidic connection being in thermal communication with the gear box, wherein upon rotation of the rotor, the gear box is activated and generates heat, and a depression region is created by the blades which causes water to enter the fluidic connection via the input opening and propagate in the manifold, the water being warmed up by the heat generated by the gear box.

33. The marine turbine assembly of claim 32, wherein the blades each comprise an output opening adjacent to an end of the leading edge and fluidly connected to the manifold for expelling the water from the manifold.

34. The marine turbine assembly of claim 32, wherein the turbine comprises at least one of an electrical generator and a hydraulic pump operatively connected to the electrical generator, each located within the nacelle, operatively connected to the gear box and in thermal communication with the fluidic connection for warming up the water propagating therein.

35. The marine turbine assembly of claim 31, further comprising a shock-absorbing device projecting frontwards from a front end of the frame and comprising a plurality of substantially U-shaped plates and a protection plate, each of the substantially U-shaped plates having a first end portion rotatably secured to the front end of the frame, a second end portion slidably secured to the frame, and a curved portion therebetween, the protection plate being secured to the curved portion of each U-shaped plate, each U-shaped plate and the protection plate being elastically deformable so that, upon collision of the protection plate with an object, at least one of the U-shaped plate rotates about an axis of the first end portion and the second end portion slides with respect to the frame in order to absorb at least some of an impact caused by the collision.
